(19) United States
(12) Patent Application Publication
(10) Pub. No.: US 2024/0110130 A1
(43) Pub. Date: Apr. 4, 2024

(54) COMPOSITION

(71) Applicant: Conopco, Inc., d/b/a UNILEVER, Englewood Cliffs, NJ (US)

(72) Inventor: Matthew Lloyd PARRY, Bebington, Wirral, Merseyside (GB)

(73) Assignee: Conopco, Inc., d/b/a UNILEVER, Englewood Cliffs, NJ (US)

(21) Appl. No.: 18/273,377

(22) PCT Filed: Jan. 20, 2022
(86) PCT No.: PCT/EP2022/051207

§ 371 Date: Jul. 20, 2023

(30) Foreign Application Priority Data
Jan. 21, 2021 (EP) 21152828.6
Mar. 12, 2021 (EP) 21162214.7

(51) Int. Cl. C11D 3/20; C11D 1/831; C11D 3/00; C11D 3/04; C11D 3/36; C11D 3/48; C11D 3/50; C11D 11/00

(52) U.S. Cl. CPC C11D 3/2096; C11D 1/831; C11D 3/0084; C11D 3/046; C11D 3/2068; C11D 3/2089; C11D 3/361; C11D 3/48; C11D 3/50; C11D 11/0017; C11D 1/22

(57) ABSTRACT

A laundry liquid composition comprising, anionic surfactant, dehydroacetic acid or salt thereof and an oxygen scavenger selected from sulfites, ascorbic acid or salts thereof, ascorbyl fatty acid esters, erythorbic acid and salts thereof, and mixtures thereof.

The present invention relates to improved liquid laundry compositions comprising dehydroacetic acid (DHA) or salt thereof.

US 2018/193243 (Koshti Nirmal) discloses a cold-processable antimicrobial composition in non-dusting solid form, free from toxic antimicrobial comprising, a) N-capryloyl glycine, b) N-undecylenoyl glycine, c) benzoic add and d) sodium dehydroacetate for use in personal care and home care products. The invention further discloses a process for preparation of the antimicrobial composition and its incorporation in various personal and home products.

WO 2002/097020 discloses a bactericidal liquid detergent composition comprising; a) from 1 percent to 50 percent, by weight of the total composition, of one or more surfactants selected from any of the following surfactant types: anionic, non-ionic, cationic and amphoteric; b) 0.01 percent to 5 percent, by weight of the total composition, of at least one non-ionic, non-phenolic antimicrobial agent selected from the following groups; benzoic acid, sorbic acid, trimethyl dodecatrienol (commonly known as ‘famesol’), dehydroacetic acid and salts thereof; c) from 0 percent to 10 percent, by weight of the total composition, of at least one aromatic sulphonate hydrotrope selected from the group consisting of: benzene sulphonate, cumene sulphonate, xylene sulphonate and toluene sulphonate; d) from 0 percent to 20 percent, by weight of the total composition, of a water soluble hydroxyl containing solvent, selected from monohydric alcohols, polyhydric alcohols and glycol ethers of the general formula R—(O—R1)n-OH (wherein R and R1 are alkyl groups, which may be the same or different, containing 1 to 4 carbon atoms and n is an integer from 1 to 3); and e) water. The sum total of components ‘c’ and ‘d’ is present in the range from 0.5 percent to 30 percent by weight of the total composition.

US 2006/051430 discloses home care compositions are disclosed, which include silver dihydrogen citrate. The inventive compositions advantageously take the form of suspensions, pastes, liquids and gels. The inventive compositions also optionally comprise additional ingredients, and are therefore suitable for a wide variety of personal, home and industrial care purposes.

DHA is an effective agent but exhibits yellowing when used in laundry liquid compositions. This yellowing leads to undesirable product aesthetics and so ways of reducing this yellowing are highly desired. The DHA is added to the composition either as the acid or, more preferably as a salt, for example sodium dehydroacetate.

Despite the prior art there remains a need for improved systems for laundry liquids. In particular, for liquid laundry compositions comprising DHA and which exhibit reduced yellowing.

Accordingly, and in a first aspect there is provided a laundry liquid composition comprising, anionic surfactant, dehydroacetic acid or salt thereof and an oxygen scavenger selected from sulfites, ascorbic acid or salts thereof, ascorbyl fatty acid esters, erythorbic acid and salts thereof, and mixtures thereof.

Anti-oxidants (whether synthetic or natural) are usually classified into two main groups:
(a) Primary (or chain breaking) antioxidants, when present in trace amounts can react with peroxy radical and convert them into more stable products before they can react with the materials being protected; and
(b) Secondary (synergistic or preventative) anti-oxidants which are compounds that retard the rate of chain initiation by various mechanisms other than the pathway followed by the primary antioxidants, and include:
   a. metal ions binders (sequesterants)
   b. oxygen scavengers
   c. hydroperoxides decomposers to non-radical products
   d. UV Radiation absorbers
   e. singlet oxygen deactivators.

The oxygen scavengers described below are from the second part.

We have surprisingly found that such an oxygen scavenger is able to reduce the yellowing seen in laundry compositions with DHA. The oxygen scavenger is selected from sulfites, ascorbic acid or salts thereof such as sodium ascorbate, ascorbyl fatty acid esters such as ascorbyl palmitate, erythorbic acid and salts thereof such as sodium erythorbate, and mixtures thereof.

More preferably, the oxygen scavenger is a sulphite or ascorbic acid and more preferably, most preferably the scavenger is sulphite. Suitable sulphites include the group I sulphites such as potassium sulphite and sodium sulphite. The most preferred is potassium sulphite.

The oxygen scavenger is present at from 0.05 to 2% wt. of the composition, more preferably from 0.1 to 1% wt. and most preferably from 0.15 to 1.5% wt. of the composition.

In a preferred embodiment the composition comprises potassium sulphite at from 0.05 to 2% wt. of the composition, more preferably from 0.1 to 1% wt. and most preferably from 0.15 to 1.5% wt. of the composition.

Dehydroacetic Acid

The composition preferably comprises from 0.001 to 2 wt %, more preferably from 0.005 to 1.5 wt %, especially preferably from 0.01 to 1 wt %, even more preferably from 0.05 to 1 wt %, further more preferably from 0.1 to 0.5 wt %, still more preferably from 0.2 to 0.5 wt %, yet more preferably from 0.2 to 0.4 wt % and still further more preferably from 0.2 to 0.3 wt % dehydroacetic acid.

Liquid Laundry Detergents

The term “laundry detergent” in the context of this invention denotes formulated compositions intended for and capable of wetting and cleaning domestic laundry such as clothing, linens and other household textiles.

The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines.

The term “liquid” in the context of this invention denotes that a continuous phase or predominant part of the composition is liquid and that the composition is flowable at 15° C. and above.

Accordingly, the term “liquid” may encompass emulsions, suspensions, and compositions having flowable yet stiffer consistency, known as gels or pastes. The viscosity of the composition may suitably range from about 200 to about 10,000 mPa·s at 25° C. at a shear rate of 21 sec⁻¹. This shear rate is the shear rate that is usually exerted on the liquid when poured from a bottle. Pourable liquid detergent compositions generally have a viscosity of from 200 to 1,500 mPa·s, preferably from 100 to 800 mPa·s.

A composition according to the invention may suitably have an aqueous continuous phase. By “aqueous continuous phase” is meant a continuous phase which has water as its basis.

A composition of the invention preferably comprises from 1 to 40%, preferably from 5 to 35%, and more preferably from 7 to 24% (by weight based on the total weight of the composition) of one or more detersive surfactants selected from non-soap anionic surfactants, nonionic surfactants and mixtures thereof.

The term “detersive surfactant” in the context of this invention denotes a surfactant which provides a detersive (i.e. cleaning) effect to laundry treated as part of a domestic laundering process.

Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of non-soap anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may be used, such as non-ethoxylated primary and secondary alkyl sulphates with an alkyl chain length of from 10 to 18.

Mixtures of any of the above described materials may also be used.

In a composition of the invention the total level of anionic surfactant may preferably range from 20 to 90% by weight based on the total weight of the surfactant.

Also commonly used in laundry liquid compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule.

Preferably, the composition comprises from 20 to 95% wt. non-ionic surfactant based on the total weight of surfactant. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

A further class of surfactants include the alkyl poly glycosides and rhamnolipids.

Mixtures of any of the above described materials may also be used.

Preferably, the selection and amount of surfactant is such that the compositions are isotropic in nature.

Methyl Ester Ethoxylate (MEE)

Preferably, the composition comprises a Methyl Ester Ethoxylate (MEE) surfactant. MEE surfactants are of the form:

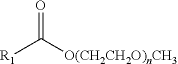

Where R₁COO is a fatty acid moiety, such as oleic, stearic, palmitic. Fatty acid nomenclature is to describe the fatty acid by 2 numbers A:B where A is the number of carbons in the fatty acid and B is the number of double bonds it contains. For example oleic is 18:1, stearic is 18:0 and palmitic 16:0. The position of the double bond on the chain may be given in brackets, 18:1(9) for oleic, 18:2 (9,12) for linoleic where 9 if the number of carbons from the COOH end.

The integer n is the mole average number of ethoxylates

Methyl Ester Ethoxylates (MEE) are described in chapter 8 of Biobased Surfactants (Second Edition) Synthesis, Properties, and Applications Pages 287-301 (AOCS press 2019) by G. A. Smith; J. Am. Oil. Chem. Soc. vol 74 (1997) page 847-859 by Cox M. E. and Weerasooriva U; Tenside Surf. Det. vol 28 (2001) page by 72-80 by Hreczuch et al; by C. Kolano. Household and Personal Care Today (2012) page 52-55; J. Am. Oil. Chem. Soc. vol 72 (1995) page 781-784 by A. Hama et al. MEE may be produced the reaction of methyl ester with ethylene oxide, using catalysts based on calcium or magnesium. The catalyst may be removed or left in the MEE.

An alternative route to preparation is transesterification reaction of a methyl ester or esterification reaction of a carboxylic acid with a polyethylene glycol that is methyl terminated at one end of the chain.

The methyl ester may be produced by transesterification reaction of methanol with a triglyceride, or esterification reaction of methanol with a fatty acid. Transesterification reactions of a triglyceride to fatty acid methyl esters and glycerol are discussed in Fattah et al (Front. Energy Res., June 2020, volume 8 article 101) and references therein. Common catalysts for these reactions include sodium hydroxide, potassium hydroxide, and sodium methoxide. Esterase and lipases enzyme may also be used. Triglycerides occur naturally in plant fats or oils, preferred sources are rapeseed oil, castor oil, maize oil, cottonseed oil, olive oil, palm oil, safflower oil, sesame oil, soybean oil, high steric/high oleic sunflower oil, high oleic sunflower oil, non-edible vegetable oils, tall oil and any mixture thereof and any derivative thereof. The oil from trees is called tall oil. Used food cooking oils may be utilised. Triglycerides may also be obtained from algae, fungi, yeast or bacteria. Plant sources are preferred.

Distillation and fractionation process may be used in the production of the methyl ester or carboxylic acid to produce the desired carbon chain distribution. Preferred sources of triglyceride are those which contain less than 35% wt polyunsaturated fatty acids in the oil before distillation, fractionation, or hydrogenation.

Fatty acid and methyl ester may be obtained from Oleochemical suppliers such as Wilmar, KLK Oleo, Unilever oleochemical Indonesia. Biodiesel is methyl ester and these sources may be used.

The methyl ester ethoxylate preferably has a mole average of from 5 to 25 ethoxylate groups (EO), more preferably from 7 to 13. The most preferred ethoxylate comprises 9 to 11EO, even more preferably 10EO.

Preferably, the MEE comprises monounsaturated C18 and wherein the weight proportion of monounsaturated C18 to other C18 components is at least 2.2, more preferably at least 2.5. Preferably, the weight proportion of monounsaturated C18 to other C18 components is up to least 10. More preferably the weight proportion of monounsaturated C18 to other C18 components is from 2.6 to 4.0.

Preferably, at least 5% wt., more preferably at least 10% wt. of the total C18:1 MEE in the composition has from 9 to 11EO, even more preferably exactly 10EO.

In the context of the wider MEE contribution, it is preferred that at least 40 wt % of the total MEE in the composition is C18:1.

A particularly preferred MEE has 20 to 50 wt % C16:0 chains, 1 to 10 wt. % C18:0 chains, 35 to 60 wt % C18:1 chains and 1 to 12 wt % C18:2 chains.

In addition, the MEE component also comprises some C16 MEE. Preferably, the total MEE component comprises from 20 to 50% wt. total MEE, C16 MEE. Preferably the C16 MEE is greater than 90 wt %, more preferably greater than 95 wt % C16:0.

Further, it is preferred that the total MEE component comprises less than 15% wt, more preferably less than 10 wt %, most preferably less than 5 wt % total MEE of polyunsaturated C18, i.e. C18:2 and C18:3. Preferably C18:3 is present at less than 1 wt %, more preferably less than 0.5 wt %, most preferably essentially absent. The levels of polyunsaturation may be controlled by distillation, fractionation or partial hydrogenation of the raw materials (triglyceride or methyl ester) or of the MEE.

Further, it is preferred that the C18:0 component is less than 8 wt % by weight of the total MEE present.

Further, it is preferred that the components with carbon chains of 15 or shorter comprise less than 4 wt % by weight of the total MEE present.

A particularly preferred MEE has 2 to 26 wt % C16:0 chains, 1 to 10 wt % C18:0 chains, 50 to 85 wt % C18:1 chains and 1 to 12 wt % C18:2 chains.

Preferred sources for the alkyl groups for the MEE include methyl ester derived from distilled palm oil and distilled high oleic methyl ester derived from palm kernel oil, partially hydrogenated methyl ester of cottonseed oil,

Preferably the double bonds in the MEE are greater than 80 wt %, preferably greater than 95% wt, in the cis configuration. Preferably the 18:1 component is oleic. Preferably the 18:2 component is linoleic.

The methyl group of the methyl ester may be replaced by an ethyl or propyl group. Methyl is most preferred.

Additional Anti-Oxidant

Preferably the composition comprises an additional anti-oxidant. More preferably, the additional anti-oxidant is one from the primary anti-oxidant group described above.

Preferably, the additional anti-oxidant is selected from: butylated hydroxyanisole (BHA), butylated hydroxytoluene (BHT) and derivatives thereof such as methyl di-butyl hydroxyhydrocinnamate (Metilox, CAS 6386-38-5), tert-butylhydroquinonne (TBHQ), trihydroxybutylphenone (THBP), hydroxymethylbutylphenol (HMBP), gallates (propyl, butyl, octyl, dodecyl), 3,4-dihydroxychalcones (butein, okanin) and mixtures thereof.

More preferably, the additional anti-oxidant is selected from butylated hydroxytoluene (BHT), 3,4-dihydroxychalcones (butein, okanin), and methyl di-butyl hydroxyhydrocinnamate (Metilox, CAS 6386-38-5) and mixtures thereof.

Preferably, the additional anti-oxidant is incorporated into the fragrance oil during manufacture.

Preferably, the additional anti-oxidant is present at from 0.05 to 2% wt. of the composition, more preferably from 0.1 to 1% wt. and most preferably from 0.15 to 1.5% wt. of the composition.

Preservative

The composition preferably comprises an additional preservative.

Preferably, the composition comprises a preservative to inhibit microbial growth. For example, preservatives may optionally be included in various embodiments as a way to further boost microbial protection for gross bacteria, virus and/or fungi contamination introduced e.g., by a consumer, through a contaminated ingredient, contaminated storage container, equipment, processing step or other source. Any conventional preservative known in the art may be used. Some illustrative preservatives include: potassium sorbate, sodium benzoate, benzoic acid, phenoxyethanol, benzyl alcohol, sodium borate, boric acid, usinic acid, phenols, quatemary ammonia compounds, glycols, isothiazolinones (methyl, benzyl, chloro), DMDM hydantoin, hexidine, ethanol, IPBC, polyaminopropyl biguanide, phenylphenol, imidazolidinyl urea, parabens, formaldehyde, salicylic acid or salts, caprylyl glycol, D-glucono-1,5 lactone, sodium erythorbate, sodium hydroxymethylglycinate, peroxides, sodium sulphite, bisulphite, glucose oxidase, lacto peroxidase, and other preservatives compatible with the cleaning ingredients. Some other natural materials might also be considered like cinnamon, fruit adds, essential oils like thyme and rosemary, willow bark, aspen bark, tocopherol, curry, citrus extracts, honeysuckle, and amino acid based preservatives. Especially preferred are preservatives that do not compete with the cleaning ingredients and do not have reported health or environmental issues. Some of the more preferred preservatives are: phenoxyethanol, benzoic acid/potassium sorbate, enzymes, borates, isothiazolinones such as MIT, BIT and CIT, and the natural solutions above. In one embodiment, the preservative is present in an amount less than about 5 wt. percent based on the total weight of the cleaning composition. In another embodiment, the preservative is present in an amount from about 0.01 to about 2 wt. percent. In another embodiment, the fragrant agent is present in an amount from about 0.01 to about 1 wt. percent.

Further preferred preservatives include sodium benzoate, itaconic acid and phenoxyethanol.

More preferably the composition comprises BIT and/or MIT at a combined level of not more than 550 ppm and more preferably at from 300 to 450 ppm. Preferably, the level of MIT does not exceed 95 ppm. Preferably, the level of BIT does not exceed 450 ppm.

Most preferably, the composition comprises benzoate salt or phenoxyethanol as preservative in addition to the DHA. Preferably the benzoate salt is present at from 0.01 to 3% wt. more preferably 0.1 to 2% wt, most preferably 0.5 to 1.5% wt. of the composition.

Anti-Foam

The concentrated product may also comprise an anti-foam. Anti-foam materials are well known in the art and include silicones and fatty acid.

Preferably, where present, the fatty acid anti-foam is present at from 1.3 to 3.0, more preferably from 1.4 to 2.0% wt. and most preferably from 1.6 to 1.65% wt. of the composition.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

For formula accounting purposes, in the formulation, fatty acids and/or their salts (as defined above) are not included in the level of surfactant or in the level of builder.

Hydrotropes

A composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M w) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, when included, may be present in an amount ranging from 0.1 to 20%, preferably from 1 to 15%, and more preferably from 3 to 12% (by weight based on the total weight of the composition).

Cosurfactants

A composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

Builders

A composition of the invention may contain one or more builders. Builders enhance or maintain the cleaning efficiency of the surfactant, primarily by reducing water hardness. This is done either by sequestration or chelation (holding hardness minerals in solution), by precipitation (forming an insoluble substance), or by ion exchange (trading electrically charged particles).

Builders for use in the invention can be of the organic or inorganic type, or a mixture thereof.

Suitable inorganic builders include hydroxides, carbonates, sesquicarbonates, bicarbonates, silicates, zeolites, and mixtures thereof. Specific examples of such materials include sodium and potassium hydroxide, sodium and potassium carbonate, sodium and potassium bicarbonate, sodium sesquicarbonate, sodium silicate and mixtures thereof.

Suitable organic builders include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Mixtures of any of the above described materials may also be used. Preferred builders for use in the invention may be selected from polycarboxylates (e.g. citrates) in acid and/or salt form and mixtures thereof.

Builder, when included, may be present in an amount ranging from about 0.1 to about 20%, preferably from about 0.5 to about 15%, more preferably from about 1 to about 10% (by weight based on the total weight of the composition).

Polymeric Cleaning Boosters

To further improve the environmental profile of liquid laundry detergents it may be preferred in some cases to reduce the volume of laundry detergent dosed per wash-load and to add various highly weight efficient ingredients to the composition to boost cleaning performance. In addition to the soil release polymers of the invention described above, a composition of the invention will preferably contain one or more additional polymeric cleaning boosters such as anti-redeposition polymers. Anti-redeposition polymers stabilise the soil in the wash solution thus preventing redeposition of the soil. Suitable soil release polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above described materials may also be used.

When included, a composition of the invention will preferably comprise from 0.025 to 8% wt. such materials, preferably from 0.5 to 6% (by weight based on the total weight of the diluted composition) of one or more anti-redeposition polymers such as, for example, the alkoxylated polyethyleneimines which are described above.

Soil Release Polymers

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M w) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic add), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

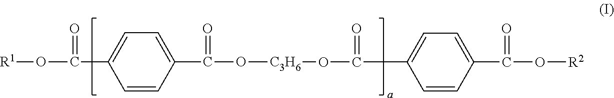

in which R¹ and R² independently of one another are X—(OC₂H₄)ₙ—(OC₃H₆)ₘ,
in which X is C₁₋₄ alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent compositions herein in concentrations ranging from 0.01 percent to 10 percent, more preferably from 0.1 percent to 5 percent, by weight of the composition.

Polymeric Thickeners

A composition of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁₋₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise from 0.01 to 5% wt., more preferably from 0.1 to 3% wt. by weight based on the total weight of the composition.

Fluorescent Agents

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt % the composition.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal SBMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

Shading Dyes

Shading dye can be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Shading dyes are well known in the art of laundry liquid formulation and suitable and preferred classes of dyes include direct dyes, acid dyes, hydrophobic dyes, basic dyes, reactive dyes and dye conjugates.

Shading dye can be used in the absence of fluorescer, but it is especially preferred to use a shading dye in combination with a fluorescer, for example in order to reduce yellowing due to chemical changes in adsorbed fluorescer.

External Structurants

Compositions of the invention may have their rheology further modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

Enzymes

A composition of the invention may comprise an effective amount of one or more enzyme selected from the group comprising, pectate lyase, protease, amylase, cellulase, lipase, mannanase and mixtures thereof. The enzymes are preferably present with corresponding enzyme stabilizers.

Fragrances

Fragrances are well known in the art and may be incorporated into compositions described herein. Preferably, the fragrance is provided as a fragrance oil and more preferably, this fragrance oil is used as a carrier for the additional anti-oxidant when used.

Preferably, the fragrance comprises a phenolic and/or ketonic species.

Microcapsules

One type of microparticle suitable for use in the invention is a microcapsule. Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material.

Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Alternatively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography.

Polymeric core-shell microcapsules for use in the invention may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future microcapsule and the dimensions of the dispersed droplets directly determine the size of the subsequent microcapsules. Microcapsule shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell microcapsules. An example of a core-shell microcapsule produced by this method is a polyurea microcapsule with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed core material to produce a coherent film and the desired microcapsules. An example of a core-shell microcapsule produced by this method is an aminoplast microcapsule with a shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

One example of a preferred polymeric core-shell microcapsule for use in the invention is an aminoplast microcapsule with an aminoplast shell surrounding a core containing the fragrance formulation (f2). More preferably such an aminoplast shell is formed from the polycondensation product of melamine with formaldehyde.

Polymeric microparticles suitable for use in the invention will generally have an average particle size between 100 nanometers and 50 microns. Particles larger than this are entering the visible range. Examples of particles in the sub-micron range include latexes and mini-emulsions with a typical size range of 100 to 600 nanometers. The preferred particle size range is in the micron range. Examples of particles in the micron range include polymeric core-shell microcapsules (such as those further described above) with a typical size range of 1 to 50 microns, preferably 5 to 30 microns. The average particle size can be determined by light scattering using a Malvern Mastersizer with the average particle size being taken as the median particle size D (0.5) value. The particle size distribution can be narrow, broad or multimodal. If necessary, the microcapsules as initially produced may be filtered or screened to produce a product of greater size uniformity.

Polymeric microparticles suitable for use in the invention may be provided with a deposition aid at the outer surface of the microparticle. Deposition aids serve to modify the properties of the exterior of the microparticle, for example to make the microparticle more substantive to a desired substrate. Desired substrates include cellulosics (including cotton) and polyesters (including those employed in the manufacture of polyester fabrics).

The deposition aid may suitably be provided at the outer surface of the microparticle by means of covalent bonding, entanglement or strong adsorption. Examples include polymeric core-shell microcapsules (such as those further described above) in which a deposition aid is attached to the outside of the shell, preferably by means of covalent bonding. While it is preferred that the deposition aid is attached directly to the outside of the shell, it may also be attached via a linking species.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of β1-4 linked glucose residues), a mannan backbone (consisting of β1-4 linked mannose residues) or a xylan backbone (consisting of β1-4 linked xylose residues). Examples of such β1-4 linked polysaccharides include xyloglucans, glucomannans, mannans, galactomannans, β(1-3),(1-4) glucan and the xylan family incorporating glucurono-, arabino- and glucuronoarabinoxylans. Preferred β1-4 linked polysaccharides for use in the invention may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as locust bean gum (LBG) (which has a mannan backbone of β1-4 linked mannose residues, with single unit galactose side chains linked α1-6 to the backbone).

Also suitable are polysaccharides which may gain an affinity for cellulose upon hydrolysis, such as cellulose mono-acetate; or modified polysaccharides with an affinity for cellulose such as hydroxypropyl cellulose, hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

Deposition aids for use in the invention will generally have a weight average molecular weight (M_{w}) in the range of from about 5 kDa to about 500 kDa, preferably from about 10 kDa to about 500 kDa and more preferably from about 20 kDa to about 300 kDa.

One example of a particularly preferred polymeric core-shell microcapsule for use in the invention is an aminoplast microcapsule with a shell formed by the polycondensation of melamine with formaldehyde; surrounding a core containing the fragrance formulation (f2); in which a deposition aid is attached to the outside of the shell by means of covalent bonding. The preferred deposition aid is selected from β1-4 linked polysaccharides, and in particular the xyloglucans of plant origin, as are further described above.

The present inventors have surprisingly observed that it is possible to reduce the total level of fragrance included in the composition of the invention without sacrificing the overall fragrance experience delivered to the consumer at key stages in the laundry process. A reduction in the total level of fragrance is advantageous for cost and environmental reasons.

Accordingly, the total amount of fragrance formulation (f1) and fragrance formulation (f2) in the composition of the invention suitably ranges from 0.5 to 1.4%, preferably from 0.5 to 1.2%, more preferably from 0.5 to 1% and most preferably from 0.6 to 0.9% (by weight based on the total weight of the composition).

The weight ratio of fragrance formulation (f1) to fragrance formulation (f2) in the composition of the invention preferably ranges from 60:40 to 45:55. Particularly good results have been obtained at a weight ratio of fragrance formulation (f1) to fragrance formulation (f2) of around 50:50.

The fragrance (f1) and fragrance (12) are typically incorporated at different stages of formation of the composition of the invention. Typically, the discrete polymeric microparticles (e.g. microcapsules) entrapping fragrance formulation (f2) are added in the form of a slurry to a warmed base formulation comprising other components of the composition (such as surfactants and solvents). Fragrance (f1) is typically post-dosed later after the base formulation has cooled.

Dilutable

Where the composition is a product to be diluted at home, the composition preferably comprises a rheology modifier preferably comprises an ethoxylated sorbitan ester viscosity modifier. The ethoxylated sorbitan ester provides improved rheological characteristics in the context of a product which is diluted by the consumer in the domestic environment. It should be noted that this is independent of any rheological behaviour which is affected by pouring or otherwise using the diluted product. The concentrated premix is to be diluted by the user and as such it is necessary for the premix to behave rheologically appropriately.

More preferably the ethoxylated sorbitan ester comprises from 50 to 1000 ethoxylate units, more preferably from 200 to 700 and most preferably from 300 to 550.

Preferably, the ethoxylated sorbitan ester comprises one to five, more preferably three to five fatty acid esters. More preferably, the ethoxylated sorbitan ester comprises a fatty acid having from 10 to 22 carbons, more preferably from 14 to 20 and most preferably 18 carbons. The fatty acid may be straight chain or branched, saturated or unsaturated. The most preferred fatty acid group is a stearic acid group.

The most preferred ethoxylated sorbitan ester is sorbeth-450 tristearate and which is the triester of stearic acid and a polyethylene glycol ether of sorbitol with an average of 450 moles of ethylene oxide.

Preferably the ethoxylated sorbitan ester is present at from 0.01-8.0% of the premix composition

Preferably, the composition comprises PEG ester fatty acid. PEG fatty acid ester is included top modify the rheological performance of the composition particularly during dilution. Preferred PEG ester fatty acids include PEG 9 cocoate, PEG 32 and PEG 175.

Preferably, the PEG ester fatty acid is present at from 0.01-5.0% of the premix composition.

Rheology modifiers suitable for use in the present invention are disclosed in WO 2017/075681.

Further Optional Ingredients

A composition of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

Many of the ingredients used in embodiments of the invention may be obtained from so called black carbon sources or a more sustainable green source. The following provides a list of alternative sources for several of these ingredients and how they can be made into raw materials described herein.

SLES and PAS

SLES and other such alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol. Accordingly, forming the linear alcohol is a central step in obtaining both PAS and alkali-metal alkyl ether sulphate surfactants.

The linear alcohols which are suitable as an intermediate step in the manufacture of alcohol ethoxylates and therefore anionic surfactants such as sodium lauryl ether sulphate ca be obtained from many different sustainable sources. These include:

Primary Sugars

Primary sugars are obtained from cane sugar or sugar beet, etc., and may be fermented to form bioethanol. The bioethanol is then dehydrated to form bio-ethylene which then undergoes olefin methathesis to form alkenes. These alkenes are then processed into linear alcohols either by hydroformylation or oxidation.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

Biomass

Biomass, for example forestry products, rice husks and straw to name a few may be processed into syngas by gasification. Through a Fischer Tropsch reaction these are processed into alkanes, which in turn are dehydrogenated to form olefins. These olefins may be processed in the same manner as the alkenes described above [primary sugars].

An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

Waste Plastics

Waste plastic is pyrolyzed to form pyrolysed oils. This is then fractioned to form linear alkanes which are dehydrogenated to form alkenes. These alkenes are processed as described above [primary sugars].

Alternatively, the pyrolyzed oils are cracked to form ethylene which is then processed to form the required alkenes by olefin metathesis. These are then processed into linear alcohols as described above [primary sugars].

Municipal Solid Waste

MSW is turned into syngas by gasification. From syngas it may be processed as described above [primary sugars] or it may be turned into ethanol by enzymatic processes before being dehydrogenated into ethylene. The ethylene may then be turned into linear alcohols by the Ziegler Process.

The MSW may also be turned into pyrolysis oil by gasification and then fractioned to form alkanes. These alkanes are then dehydrogenated to form olefins and then linear alcohols.

Marine Carbon

There are various carbon sources from marine flora such as seaweed and kelp. From such marine flora the triglycerides can be separated from the source and which is then hydrolysed to form the fatty acids which are reduced to linear alcohols in the usual manner.

Alternatively, the raw material can be separated into polysaccharides which are enzymatically degraded to form secondary sugars. These may be fermented to form bio-ethanol and then processed as described above [Primary Sugars].

Waste Oils

Waste oils such as used cooking oil can be physically separated into the triglycerides which are split to form linear fatty acids and then linear alcohols as described above.

Alternatively, the used cooking oil may be subjected to the Neste Process whereby the oil is catalytically cracked to form bio-ethylene. This is then processed as described above.

Methane Capture

Methane capture methods capture methane from landfill sites or from fossil fuel production. The methane may be formed into syngas by gasification. The syngas may be processed as described above whereby the syngas is turned into methanol (Fischer Tropsch reaction) and then olefins before being turned into linear alcohols by hydroformylation oxidation.

Alternatively, the syngas may be turned into alkanes and then olefins by Fischer Tropsch and then dehydrogenation.

Carbon Capture

Carbon dioxide may be captured by any of a variety of processes which are all well known. The carbon dioxide may be turned into carbon monoxide by a reverse water gas shift reaction and which in turn may be turned into syngas using hydrogen gas in an electrolytic reaction. The syngas is then processed as described above and is either turned into methanol and/or alkanes before being reacted to form olefins.

Alternatively, the captured carbon dioxide is mixed with hydrogen gas before being enzymatically processed to form ethanol. This is a process which has been developed by Lanzatech. From here the ethanol is turned into ethylene and then processed into olefins and then linear alcohols as described above.

LAS

One of the other main surfactants commonly used in cleaning compositions, in particular laundry compositions is LAS (linear alkyl benzene sulphonate).

The key intermediate compound in the manufacture of LAS is the relevant alkene. These alkenes (olefins) may be produced by any of the methods described above and may be formed from primary sugars, biomass, waste plastic, MSW, carbon capture, methane capture, marine carbon to name a few.

Whereas in the processed described above the olefin is processed to form linear alcohols by hydroformylation and oxidation instead, the olefin is reacted with benzene and then sulphonate to form the LAS.

Packaging and Dosing

A composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of laundering fabric using a composition of the invention will usually involve diluting the dose of detergent composition with water to obtain a wash liquor, and washing fabrics with the wash liquor so formed.

In a third aspect there is provided a method for forming a laundry detergent composition by diluting a composition as described above in water to form a laundry liquid composition. In such an instance, the composition to be diluted by the consumer is referred to as a premix.

The consumer may add water to the concentrated premix, or alternatively concentrated premix to the water depending on the preferred consumer behaviour in any particular market. Where the premix is added to water, the premix is made available to the consumer in a regular pack conforming with the volume of the premix purchased. In such instances it is preferred that the packaged premix is available with an appropriately dimensioned dilution container in which water is added from a domestic supply and to which the premix is added to form the functional liquid detergent composition.

Preferably, by diluting said premix 0.8 to 1 to 10 to 1 in water (water to premix). The degree of dilution is also dependent on market choice. In some markets a more concentrated product is desired while in others a more dilute product is preferred. The amount of water instructed to be used is thus variable but it is preferred that the dilution is at least 1:1 and preferably no more than 5 to 1, water to concentrated premix.

In a fourth aspect there is provided a container comprising a premix as described in the first aspect. Containers include bottles, tottles, sealable bags and doy-packs and such like. Preferably, the container has an orifice which may provide means for adding water from a domestic supply to the container containing a concentrated premix. It is also preferred that the container comprises a means for adding water to the container and a separate means for permitting diluted contents to be dispensed. In such an embodiment the means for adding water is preferably near the top of the container when in a standing disposition and the means for permitting diluted contents to be dispensed is disposed near the bottom in the same disposition.

The container may also be of an expansible type wherein the container as purchased by the consumer is to be expanded before dilution with water from a domestic supply.

For example, the consumer purchases a container which is folded such that it contains a first volume of concentrated premix and is optionally packaged within a secondary package such that the consumer sees only a regular box or carton. Inside such secondary pack is a bag or other such container and which contains the premix. Water is added from a domestic supply and the concentrate is thus diluted to form the liquid laundry treatment composition which can be used in a regular way by the consumer. For example, it may be added to a shuttle device and placed inside a washing machine drum or it may be dispensed into a washing machine drawer.

The water supplied may also be filtered prior to use. This is at the consumer's discretion but it is expected that the concentrated premix described herein is suitable for a wide variety of water hardnesses.

Preferably, the container displaces a volume appropriate to permit dilution of said premix to form a liquid detergent composition at an appropriate dilution. For example, container may have internal volume (V) and the premix supplied in the container may have volume V/3. In such an embodiment the consumer will be directed to add two parts of water to one part of premix such that the volume of diluted premix is substantially equal to V.

In an alternative embodiment the premix is marketed in a container of appropriate size to match the volume sold, together with a ‘keeper’ container which can be sold filled with diluted product or empty as the consumer prefers. The pre-mix container and the keeper container are maintained together by a form of secondary wrapping such as shrink wrap.

The keeper may have a marker assisting the user in achieving the correct dilution levels.

### EXAMPLES

Data showing that adding sulphite reduces yellowing.

| | 1 | 2 | 3 | 4 | 5 | 6 | 7 |
|---|---|---|---|---|---|---|---|
| | % wt. as | % wt. as | % wt. as | % wt. as | % wt. as | % wt. as | % wt. as |
| | 100% | 100% | 100% | 100% | 100% | 100% | 100% |
| | active | active | active | active | active | active | active |
| Potassium | 0 | 0 | 0.2 | 0.2 | 0.2 | 0 | 0 |
| Sulfite | | | | | | | |
| Geogard 111 S | 0 | 0.565 | 0.565 | 0.565 | 0.565 | 0.565 | 0.565 |
| (sodium salt of | | | | | | | |
| dehydroacetic | | | | | | | |
| acid) | | | | | | | |
| BHT | 0 | 0 | 0 | 0.2 | 0 | 0.2 | 0 |
| Metilox (CAS | 0 | 0 | 0 | 0 | 0.2 | 0 | 0.2 |
| No. 6386-38-5) | | | | | | | |
| Sodium | 1 | 1 | 1 | 1 | 1 | 1 | 1 |
| Benzoate | | | | | | | |
| LAS acid | 9.94 | 9.94 | 9.94 | 9.94 | 9.94 | 9.94 | 9.94 |
| C16-18-10EO | 7.45 | 7.45 | 7.45 | 7.45 | 7.45 | 7.45 | 7.45 |
| nonionic | | | | | | | |
| surfactant | | | | | | | |
| C1214 3EO | 7.45 | 7.45 | 7.45 | 7.45 | 7.45 | 7.45 | 7.45 |
| ether sulfate | | | | | | | |
| sodium salt | | | | | | | |
| EPEI | 2.16 | 2.16 | 2.16 | 2.16 | 2.16 | 2.16 | 2.16 |
| Polyester soil | 0.54 | 0.54 | 0.54 | 0.54 | 0.54 | 0.54 | 0.54 |
| release | | | | | | | |
| polymer | | | | | | | |
| Dequest 2010 | 2.16 | 2.16 | 2.16 | 2.16 | 2.16 | 2.16 | 2.16 |
| (HEDP | | | | | | | |
| sequesterant) | | | | | | | |
| Tinopal CBS-X | 0.2 | 0.2 | 0.2 | 0.2 | 0.2 | 0.2 | 0.2 |
| (optical | | | | | | | |
| brightener) | | | | | | | |
| Perfume | 1.18 | 1.18 | 1.18 | 1.18 | 1.18 | 1.18 | 1.18 |
| Cellulase (wt. | 0.36 | 0.36 | 0.36 | 0.36 | 0.36 | 0.36 | 0.36 |
| received) | | | | | | | |
| amylase/man- | 0.36 | 0.36 | 0.36 | 0.36 | 0.36 | 0.36 | 0.36 |
| nanase blend | | | | | | | |
| (wt. as | | | | | | | |
| received) | | | | | | | |
| Protease (wt. | 0.9 | 0.9 | 0.9 | 0.9 | 0.9 | 0.9 | 0.9 |
| as received) | | | | | | | |
| MPG | 3 | 3 | 3 | 3 | 3 | 3 | 3 |
| Anti foam | 0.001 | 0.001 | 0.001 | 0.001 | 0.001 | 0.001 | 0.001 |
| NaOH | ~2.18 | ~2.18 | ~2.18 | ~2.18 | ~2.18 | ~2.18 | ~2.18 |
| (adjusted to 6.5 | | | | | | | |
| with additional | | | | | | | |
| NaOH) | | | | | | | |
| Demin water | Balance | Balance | Balance | Balance | Balance | Balance | Balance |
| TOTAL | 100% | 100% | 100% | 100% | 100% | 100% | 100% |
| PH | 6.5 | 6.5 | 6.5 | 6.5 | 6.5 | 6.5 | 6.5 |
| | 1 | 2 | 3 | 4 | 5 | 6 | 7 |
| DL* | −1.06 D | −5.73 D | −3.94 D | −1.42 D | −2.35 D | −6.45 D | −6.05 D |
| Da* | −3.95 G | −5.57 G | −7.38 G | −5.20 G | −5.44 G | −4.99 G | −5.37 G |
| Db* | 12.49 Y | 45.49 Y | 40.40 Y | 17.56 Y | 23.37 Y | 48.48 Y | 46.58 Y |
| DEcmc | 20.13 | 70.45 | 63.12 | 28.14 | 36.87 | 74.91 | 72.08 |
| L* | 95.24 | 90.56 | 92.35 | 94.87 | 93.95 | 89.85 | 90.25 |
| a* | −4.06 | −5.68 | −7.5 | −5.31 | −5.55 | −5.1 | −5.49 |
| b* | 12.66 | 45.66 | 40.57 | 17.73 | 23.54 | 48.64 | 46.75 |
| Yellowing | EXCEL- | POOR | GOOD | EXCEL- | EXCEL- | POOR | POOR |
| | LENT | | | LENT | LENT | | |

1. A laundry liquid composition comprising, anionic surfactant, dehydroacetic acid or salt thereof and an oxygen scavenger selected from sulfites, ascorbic acid or salts thereof, ascorbyl fatty acid esters, erythorbic acid and salts thereof, and mixtures thereof.

2. Composition according to claim 1 wherein the scavenger is group 1 metal sulphite.

3. Composition according to claim 1 comprising non-ionic surfactant.

4. Composition according to claim 1 comprising a phosphonic acid based sequestrant.

5. Composition according to claim 1 comprising an anti-bacterial preservative.

6. Composition according to claim 1 comprising a hydrotrope.

7. Composition according to claim 1 having a viscosity measured at 21 s⁻¹ of from 100 to 800 mPa·s.

8. Composition according to claim 1 comprising a fragrance oil.

9. Composition according to claim 1 comprising a phenolic and/or ketonic fragrance component.

10. Composition according to claim 1 comprising an anti-oxidant selected from butylated hydroxyanisole (BHA), butylated hydroxytoluene (BHT) and derivatives thereof, tert-butylhydroquinonne (TBHQ), trihydroxybutylphenone (THBP), hydroxymethylbutylphenol (HMBP), gallates, 3,4-dihydroxychalcones (butein, okanin) and mixtures thereof.

11. Composition according to claim 1 comprising sodium benzoate or phenoxyethanol.
